(19) United States
(12) Patent Application Publication
(10) Pub. No.: US 2026/0140607 A1
(43) Pub. Date: May 21, 2026

(54) MACHINE LEARNING-BASED PROPERTY IMAGE MATCHING ANALYSIS

(71) Applicant: CoreLogic Solutions, LLC, Irvine, CA (US)

(72) Inventor: Sowkhya Pradhay Ramamurthy, Toronto (CA)

(21) Appl. No.: 19/390,203

(22) Filed: Nov. 14, 2025

Related U.S. Application Data
(60) Provisional application No. 63/721,732, filed on Nov. 18, 2024.

(51) Int. Cl. G06F 3/0484; G06F 3/0482; G06F 16/532; G06F 16/538; G06Q 50/16

(52) U.S. Cl. CPC G06F 3/0484; G06F 3/0482; G06F 16/532; G06F 16/538; G06Q 50/16

(57) ABSTRACT

Systems and methods for retrieving property using machine learning based image matching. In some embodiments, images from a user request can be provided to a matching model configured to retrieve similar images and corresponding property listings. In some embodiments, this allows a user to find additional similar listings based on photo gallery images of existing property listings. In some embodiments, this allows a user to upload a new image to search for existing properties. By accessing a machine learning model, such as a matching model, the property listing system can retrieve a number of matching images associated with property listings to be scored, ranked, and presented to a user.

### CROSS-REFERENCE TO RELATED APPLICATIONS

This present application claims priority from U.S. Provisional No. 63/721,732, filed on Nov. 18, 2024, entitled MACHINE LEARNING-BASED PROPERTY IMAGE MATCHING ANALYSIS, which is incorporated by reference in its entirety.

### BACKGROUND

Property listings on websites and other online platforms typically include a photo gallery experience. When searching for properties, users typically engage in property listings through images in a listing photo gallery. These images can include various views of the property listing, such as aerial images, interior images of rooms, floorplans, blueprints, diagrams, and the like.

### SUMMARY

The systems, methods, and devices of this disclosure each have several innovative aspects, no single one of which is solely responsible for all of the desirable attributes disclosed herein. Details of one or more implementations of the subject matter described in this specification are set forth in the accompanying drawings and descriptions below.

In some aspects, the techniques described herein relate to a system, comprising: a computer-readable storage medium storing computer-executable instructions; and one or more processors, wherein the computer-executable instructions, when executed by the one or more processors, cause the one or more processors to: process a first image and an instruction received from a user device; provide the first image and the instruction as an input to a matching model, wherein providing the first image and the instruction as input to the matching model causes the matching model to output a second image associated with a first property listing; determine a first confidence score relating to a first similarity between the first image and the second image; determine that the first confidence score is above a confidence threshold; and cause the first property listing to be displayed in a user interface on the user device, wherein the first property listing includes the second image.

In some aspects, the techniques described herein relate to a system comprising a computer-readable storage medium storing computer-executable instructions, wherein the computer-executable instructions, when executed, further cause the one or more processors to process a third image received from the user device.

In some aspects, the techniques described herein relate to a system comprising a computer-readable storage medium storing computer-executable instructions, wherein the computer-executable instructions, when executed, further cause the one or more processors to provide the first image, the third image, and the instruction as input to the matching model to cause the matching model to output the second image associated with the first property listing; determine a second confidence score relating to a second similarity between the third image and the second image; and determine that the first confidence score and the second confidence score are above the confidence threshold.

In some aspects, the techniques described herein relate to a system comprising a computer-readable storage medium storing computer-executable instructions, wherein the computer-executable instructions, when executed, further cause the one or more processors to provide the first image, the third image, and the instruction as input to the matching model to cause the matching model to output the second image associated with the first property listing and a fourth image associated with a second property listing; determine a second confidence score relating to a second similarity between the third image and the fourth image; and rank the second image and the fourth image based on a comparison between the first confidence score and the second confidence score.

In some aspects, the techniques described herein relate to a system wherein ranking of the first image and the third image is based on a weighted average.

In some aspects, the techniques described herein relate to a system, wherein the instruction is a request for property listings similar to the first image.

In some aspects, the techniques described herein relate to a system, wherein the matching model is to output a third image associated with a second property listing.

In some aspects, the techniques described herein relate to a system comprising a computer-readable storage medium storing computer-executable instructions, wherein the computer-executable instructions, when executed, further cause the one or more processors to determine a second confidence score relating to a similarity between the first image and the third image; and rank the first property listing and the second property listing based on a comparison between the first confidence score and the second confidence score.

In some aspects, the techniques described herein relate to a system comprising a computer-readable storage medium storing computer-executable instructions, wherein the computer-executable instructions, when executed, further cause the one or more processors to filter the first property listing based on a filter parameter.

In some aspects, the techniques described herein relate to a system, wherein the matching model is a machine learning model.

In some aspects, the techniques described herein relate to a method, comprising: accessing a first property listing on a user device, wherein the first property listing includes a first image; providing the first image as input into a matching model, wherein providing the first image as input to the matching model causes the matching model to output a second image included with a second property listing; determining a first confidence score relating to a first similarity between the first image and the second image; determining that the first confidence score is above a confidence threshold; and displaying the second property listing, wherein the second property listing includes the second image.

In some aspects, the techniques described herein relate to a method, wherein the first property listing includes a plurality of images.

In some aspects, the techniques described herein relate to a method, wherein the matching model is to output a third image associated with the second property listing.

In some aspects, the techniques described herein relate to a method, further comprising: determining a second confidence score relating to a similarity between the first image and the third image; and ranking the first property listing and the second property listing based on a comparison between the first confidence score and the second confidence score.

In some aspects, the techniques described herein relate to a method, wherein ranking of the first image and the third image is based on a weighted average.

In some aspects, the techniques described herein relate to a method, further comprising filtering the first property listing based on a filter parameter.

In some aspects, the techniques described herein relate to one or more non-transitory computer-readable media storing computer-executable instructions that, when executed by a computing system comprising a processor, cause the computing system to: process a first image and an instruction received from a user device; provide the first image and the instruction as an input to a matching model, wherein providing the first image and the instruction as input to the matching model causes the matching model to output a second image associated with a first property listing; determine a first confidence score relating to a similarity between the first image and the second image; determine that the first confidence score is above a confidence threshold; and cause the first property listing to be displayed in a user interface on the user device, wherein the first property listing includes the second image.

In some aspects, the techniques described herein relate to one or more non-transitory computer-readable media, wherein the matching model is to output a third image associated with a second property listing.

In some aspects, the techniques described herein relate to one or more non-transitory computer-readable media storing computer-executable instructions, wherein the computer-executable instructions, when executed, further cause the computing system to: determine a second confidence score relating to a similarity between the first image and the third image; and rank the first property listing and the second property listing based on a comparison between the first confidence score and the second confidence score.

In some aspects, the techniques described herein relate to one or more non-transitory computer-readable media storing computer-executable instructions, wherein the computer-executable instructions, when executed, further cause the computing system to filter the first property listing based on a filter parameter.

### BRIEF DESCRIPTION OF THE DRAWINGS

Various features will now be described with reference to the following drawings. Throughout the drawings, reference numbers can be re-used to indicate correspondence between referenced elements. The drawings are provided to illustrate examples described herein and are not intended to limit the scope of the disclosure.

FIG. 1 is a schematic block diagram of an example network environment in which a property listing system may operate, according to various aspects of the present disclosure.

FIG. 2 is an example data flow process in which the property listing system may operate to retrieve listings based on image matching, according to various aspects of the present disclosure.

FIG. 3 is an example interface in which the property listing system receives a request to perform a property image search.

FIGS. 4A-4B is an example interface in which the property listing system operates to retrieve listings based on image matching, according to various aspects of the present disclosure.

FIG. 5 is a block diagram illustrating components of an example computing system that can be used to implement the various systems and methods described herein.

FIG. 6 is a flow diagram showing an example routine for searching for property listings based on an image matching request.

FIG. 7 is a flow diagram showing an example routine for searching for property listings based on image matching of a current property listing.

### DETAILED DESCRIPTION

Generally described, aspects of the present disclosure relate to efficient mechanisms for searching for property listings based on machine-learning based image matching.

Users searching for properties may have a general idea of the property style or even interior design that is desired. However, existing search engines lack technical features that would enable a user to search for a specific style or design. For example, searching for properties of a specific style or “look” may be difficult to express through text-based searching. In the case when a user can describe a desired style or look using text and/or certain keywords, images depicting said styles may not be labeled with the same keywords input by the user. Thus, search results based on text queries may be incomplete or inaccurate. In an additional example, a user might have access to an image that depicts the style or look in which they are interested. In such a situation, the user may perform a reverse image search in an attempt to identify images that depict a similar look or style. However, the resulting images may not be tied to existing property listings on real estate platforms. In some cases, the resulting images may depict an identical location as the location depicted in the queried image, which may be unhelpful to a user trying to find a similar look in a different location. A general reverse image search can also result in images that primarily consist of specific objects depicted in the queried image rather than the look or style viewed in the aggregate.

In addition, even assuming that a user was able to obtain useful search results by reverse image searching (which is difficult for the reasons discussed above), the user may be limited to searching using images captured by the user. For example, unless the user screenshots a resulting image and inputs it back into the reverse image engine, the user cannot easily find additional images stemming from resulting images.

As discussed herein, the property listing system includes features that provide a technical benefit over existing search engines and existing real estate platforms. For example, the property listing system can be configured to retrieve property listings based on machine-learning (ML)-based image matching. Specifically, the property listing system can retrieve an image (or multiple images), such as one included in a user request. Alternatively, or in addition, the property listing system can automatically update current property listings to include similar property listings based on image matching of existing photos in the property listing's photo gallery. In response to retrieving an image that can depict a requested style or “look” relating to a property (e.g., a cottage-looking house), the property listing system can, by using a machine learning model, retrieve property listings containing images of a similar style. The search results may be more accurate than those received with existing search engines, and this may reduce the number of queries or text-based searching that a user might normally do to find properties associated with a certain style. In some embodiments, the property listing system can input a portion of an image (or alternatively, may omit portions of the image) into the model to generate related images. This can allow for the retrieval of more accurate and tailored images in response to a request.

In addition to retrieving property listings based on an input image, the property listing system can associate a confidence score with the requested images based on a similarity between the input image and the requested image. This process allows the property listing system to generate rankings, or orderings in which to display the resulting images (e.g., the property listings) to a user. Other processes, such as displaying the results in a search results interface or property listing gallery, can also be performed by the property listing system. This allows the process for searching for related properties based on an existing property's images to be streamlined and built into existing property platforms.

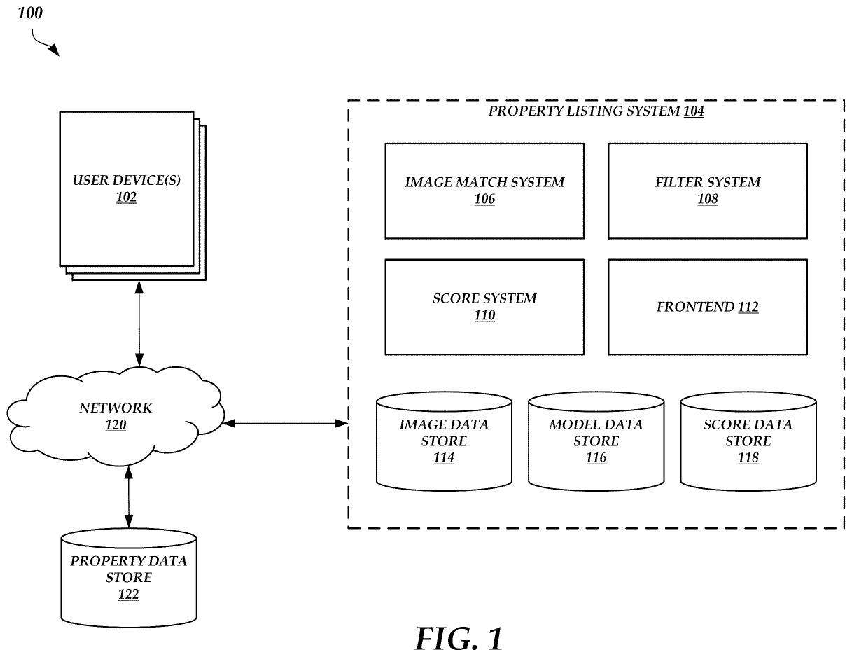

FIG. 1 is a schematic block diagram of an example network environment 100 in which a property listing system 104 may operate, according to various aspects of the present disclosure. The property listing system 104 may be configured to search for property listings based on machine learning (ML)-based image matching.

As shown in FIG. 1, the network environment 100 includes user device(s) 102 (hereinafter referred to as “user device 102” for ease of reference), property listing system 104, and network 120. Property listing system 104 includes image match system 106, filter system 108, score system 110, frontend 112, image data store 114, model data store 116, and score data store 118. The components of the property listing system 104 within network environment 100 may be communicatively coupled via network 120. In addition, network 120 may connect the user device 102 to the property listing system 104 and various components of the property listing system 104. The network environment 100 and components of the network environment 100 can include various hardware components and software components and can provide functionality as described further herein. In addition, components of the network environment 100 and the property listing system 104 can include more or less components.

In various aspects, communication among the various components of the example network environment 100 and the property listing system 104 may be accomplished via any suitable device, systems, methods, and/or the like. For example, the property listing system 104 may communicate with the user device 102 and any other systems (not shown), via any combination of the network 120 or any other wired or wireless communication networks, methods (e.g., Bluetooth, Wi-Fi, infrared, cellular, and/or the like). As further described below, the network 120 may comprise, for example, one or more internal or external networks, the Internet, and/or the like.

Network 120 of the network environment 100 can include any appropriate network, including wired network, wireless network, or combination thereof. For example, network 120 may be a personal area network, local area network, wide area network, cable network, satellite network, cellular network, or any other such network or combination thereof. As a further example, the network 120 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 120 may be a private or semi-private network, such as a corporate or university intranet. The network 120 may include one or more wireless networks, such as a Global System for Mobile Communications (GSM) network, a Code Division Multiple Access (CDMA) network, a Long-Term Evolution (LTE) network, C-band, mmWave, sub-6GHz, or any other type of wireless network. The network 120 can use protocols and components for communicating via the Internet or any of the other aforementioned types of networks. For example, the protocols used by the network 120 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 120 can represent a network that may be local to a particular organization, e.g., a private or semi-private network, such as a corporate or university intranet. In some implementations, devices may communicate via the network 120 without traversing an external network, such as the Internet. In some implementations, devices connected via the network 120 may be walled off from accessing the Internet. As an example, the network 120 may not be connected to the Internet. Accordingly, e.g., the user device 102 may communicate with the property listing system 104 directly (via wired or wireless communications) or via the network 120, without using the Internet. Thus, even if the network 120 or the Internet is down, the property listing system 104 may continue to communicate and function via direct communications (and/or via the network 120).

User device 102 may be used to access various components of the network environment 100 and the property listing system 104 over the network 120. User device 102 illustratively correspond to any computing device that provides a means for a user or admin to interact with components of the property listing system 104. For example, a property owner, with user device 102, may access the property listing system 104 via the frontend 112 to input feedback relating to a contract job. In some examples, the frontend 112 may be implemented on user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, augmented reality (AR) devices, virtual reality (VR) devices (e.g., AR/VR glasses or headsets), and the like. In some implementations, user device 102 can access a cloud provider network via the network 120 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Property listing system 104 can include any system, program, application, etc. configured to provide access to property listings. Property listings may be associated with the sale, rental, lease, etc. of any property (e.g., house, apartment, condo, land, estate, co-op, townhouse, duplex, single family, multi family, vacation rental, rentals, cabins). Property listings may also include any number of images, which may depict various rooms, views, floorplans, blueprints, layouts, charts, etc. associated with the property.

Property listing system 104 can be configured to search for property listings based on ML-based image matching. Property listing system 104 may have access to various databases, models, and other applications that allow the property listing system 104 to search for and retrieve property listings based on similar images. As shown in FIG. 1, the property listing system 104 includes various systems, such as the image match system 106, the filter system 108, the score system 110, and the frontend 112. In addition, the property listing system 104 has access to various databases or data stores, such as the image data store 114, the model data store 116, and the score data store 118. Property listing system 104 may include or have access to additional components not shown in FIG. 1, or may have less components than as shown. Each component of the property listing system 104 will be discussed in turn below.

To facilitate interaction between the property listing system 104 and a user of the user device 102 via the network 120, the property listing system 104 includes the frontend 112. Frontend 112 may include any presentation layer (e.g., experience layer, user interface, etc.) such as a user-facing interface or platform through which a user of the user device 102 may access and interact with the property listing system 104. In some embodiments, a user of the user device 102 may browse and/or search for property listings, such as on a website via the frontend 112.

To search for property listings based on ML-based image matching, the property listing system 104 may access various systems or components. Property listing system 104 may comprise various systems or modules configured to execute processes directed to searching for a property listing containing similarly matched images, filtering the property listing(s), and determining a score with the matched images. In some embodiments, various flows or data paths may be taken based on the context (e.g., user request v. automated similar listings). In some embodiments, in a first part, the property listing system 104 can access an image, such as an image uploaded by a user or included within an existing property listing.

As noted herein, the property listing system 104 may be configured to search for property listings based on image matching. Image data store 114 may be configured to store images associated with property listings of the property listing system 104. Images stored in the image data store 114 can include any image associated with a property listing, such as an exterior image of the property, aerial images, interior images of rooms, floorplans, blueprints, diagrams, and the like. In some embodiments, the image data store 114 organizes or groups images based on the property listing.

Property data store 122 can be configured to store information relating to properties. In some embodiments, the image data store 114 is integrated or combined with the property data store 122. In some embodiments, the property data store 122 can store property listings associated with the property listing system 104. As noted herein, property listings stored in the 122 may be associated with the sale, rental, lease, etc. of any property (e.g., house, apartment, condo, land, estate, co-op, townhouse, duplex, single family, multi family, vacation rental, rentals, cabins). In some embodiments, the property data store 122 is updated with additional properties and/or additional information relating to the stored properties. Property listings may also include any number of images, which may depict various rooms, views, floorplans, blueprints, layouts, charts, etc. associated with the property. Images associated with the properties stored in the property data store 122 can be stored in the image data store 114. Property data store 122 and image data store 114 are shown in FIG. 1 as separate data stores, but in some embodiments, may be combined. Property data store 122 is shown in FIG. 1 as outside of the property listing system 104 and connected via the network 120. In some embodiments, the property data store 122 is located within the property listing system 104. In some embodiments, the processes described herein relating to the image data store 114 can be executed with respect to the property data store 122.

Image match system 106 may be configured to search for similar images associated with property listings based on image matching. In some embodiments, the image match system 106 can access or receive an image of a property, such as one included in a user request to find similar images and/or property listings. Image match system 106 can then access a model, such as one stored in the model data store 116, to provide the image and an instruction as input into the model. In response to the input, the model can output an image (such as one stored in the image data store 114) that is determined to be similar to the input image.

Model data store 116 may be configured to store models, algorithms, or other processes to be accessed by the image match system 106. Models, such as a matching model, stored in the model data store 116 may include any engine, service, application, program, process, etc. configured to retrieve a similar image or images based on an input image (or multiple images). In some embodiments, the models stored in the model data store 116 may include any artificial intelligence (AI) models such as machine learning (ML) models, deep learning (DL) models, large language models (LLMs), and the like. Models stored in the model data store 116 and accessed by the property listing system 104 may be configured to retrieve an image (or a plurality of images) from the image data store 114 determined to be similar (or a match) to an input image. In some embodiments, the models stored in the model data store 116 can include AI-based vector searching models. For example, vector searching models can be configured to search for semantically similar and/or related items. In some embodiments, vector searching and/or related techniques can be used to identify matching images within the image data store 114.

In addition, models stored in the model data store 116 can be trained prior to, or during use within the property listing system 104. Models can be trained on training data, which can include labeled image pairs (e.g., matching images) and/or groups of matched images. To train the model, the property listing system 104 (or other training system) can input training data consisting of labeled image matches (e.g., where matching images are labeled to indicate that they are a match and an object, feature, or other item depicted in the images that results in a match and/or sets of images that are labeled to indicate that they are not a match and an object, feature, or other item depicted in the images that results in a match not being found). By training the matching model, the matching model may be trained to retrieve similar images based on the input image or images.

Filter system 108 can be configured to apply filters or conditions (e.g., a filter parameter) to the images (and/or corresponding property listings) retrieved by the image data store 114. Users of the property listing system 104, when searching for particular properties, for example, may set filters to narrow the search. For example, a user of the property listing system 104 may be searching for properties in Miami, Florida, with 1 bedroom and 1 bathroom. Filter parameter can include any condition, constraint, parameter, specification with respect to a property listing. For example, filter parameters can include a listing type (e.g., sale, rent), a property type (e.g., house, apartment, condo, land, estate, co-op, townhouse, duplex, single family, multi family, vacation rental, rentals, cabins), a price, a number of rooms (e.g., bedrooms, bathrooms), an area (e.g., square footage), size, year built, stories, features or amenities (e.g., pool, fireplace, pets allowed, garage, basement, furnished, water/lake front, parking), upcoming open house (e.g., virtual, in person), and any other keywords. Filters can also include an address, neighborhood, city, zip code, etc. In some embodiments, filters are applied along with a request to retrieve property listings based on the input image. In some embodiments, filters can be applied after a request is processed by the image match system 106 and images are retrieved. A user of the property listing system 104, such as via the image data store 114, may input any filter parameters to the results from the property listing system 104.

Score system 110 may be configured to generate a score, such as a confidence score, associated with the images retrieved by the image match system 106. The scores generated by the score system 110 can relate to a similarity between the input image and the retrieved/output images. The score can include a percentage, a number, a fraction, a descriptor, or any other qualitative or quantitative indication of the similarity between the input image the retrieved image. For example, a confidence score associated with an output image can indicate a 75% match with the input image. In another example, the confidence score can indicate that the output image is “fairly good” match. Scores and other labels associated with the output images can be stored in the score data store 118.

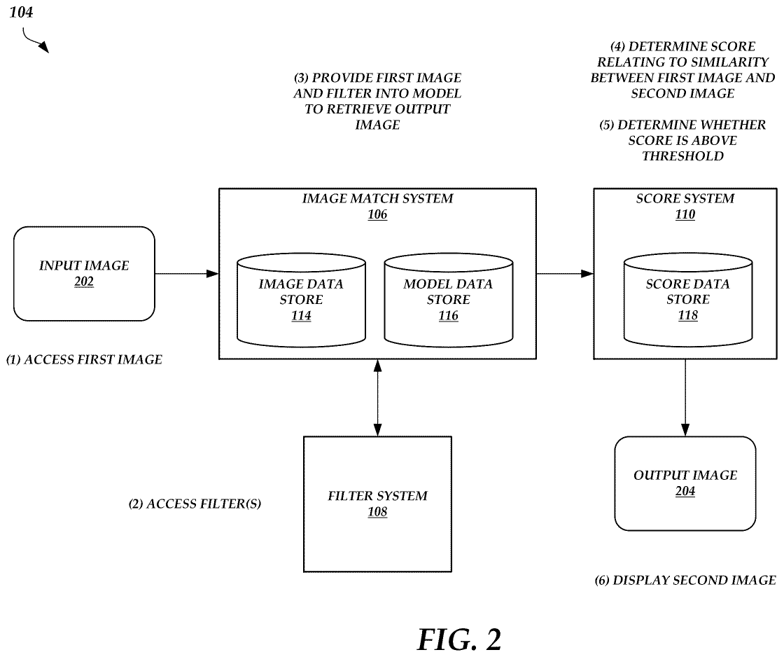

FIG. 2 is an example data flow process in which the property listing system 104 may operate to search for property listings based on image matching.

As shown in FIG. 2, the property listing system 104 accesses, at (1), an input image 202 or multiple input images 202. In some embodiments, the property listing system 104 receives a request, such as a user request, to find similar properties (e.g., based on a property's included images) based on the input image 202. In some embodiments, the property listing system 104 automatically requests similar property listings based on the images of existing property listings. In this example, the property listing system 104 may display, for a current property listing, similar or suggested property listings that include images that are similar to the current property listing.

Input image 202 can include any image relating to a property, such as an exterior image of the property, aerial images, interior images of rooms, floorplans, blueprints, diagrams, drawings, and the like. In some embodiments, the input image 202 does not need to be an image of a property that exists (e.g., can be a drawing, rendering). In some examples, more than one image can be accessed by the property listing system 104 at (1). For example, the user may, in a request, upload more than one image to be included. In another example, the property listing system 104 may access a current property listing that includes multiple images. In some embodiments, a user of the property listing system 105 may select or pin images from property listings, such as from the image data store 114. In some embodiments, a user can create a list or collection of saved or pinned images, such as part of a vision board, etc. Images may be selected by the user from multiple listings. In some embodiments, the user may provide the collection of images into the image match system 106. For example, the user may run a search using the image match system 106 to access similar images or listings.

At (2), the property listing system 104 accesses the filter system 108. It is noted that the property listing system 104 can access the filter system 108 before or after the steps described in (3). In some embodiments, a user requesting an image match search may upload the input image 202 along with filters or other search parameters. In this case, the property listing system 104 may retrieve images from the image data store 114 relating to properties that fall within the specified filters. For example, the user can upload an image of an exterior of a colonial style house. In addition to the upload of the image, the user can specify parameters such as a location and a price range. In this example, in response to the request, the image match system 106 will input the image into the model, the model configured to retrieve images (and the corresponding property listing) from the model data store 116 that are similar to the requested image. In addition, the image match system 106 may filter the images based on the filtering criteria before the property listings are presented to a user. In some embodiments, the user may request an image match search for properties based on the input image 202. Upon retrieving the matching images from the image data store 114 corresponding to the request, the user can filter the results based on specified filters.

At (3), the image match system 106 provides the input image 202 (or a plurality of images) as input into a model. As noted herein, the model can be stored in the model data store 116 and can include any model, such as a matching model, configured to match the input image 202 with images from the image data store 114. To do so, the matching model may receive an input image and retrieve images from the image data store 114 determined to be similar to the input image.

To determine whether an image of the image data store 114 is a match to the input image 202, the image match system 106 may, through the model, determine a similarity between the images. The model of the model data store 116 can utilize any computer vision, reverse image, or image processing technique to determine the similarity. This can involve the extraction and matching of characteristic between the images, such as hue, consistency, form, or even other deep neural network embeddings, to gauge similarity. In some embodiments, a semantic similarity can also be utilized to determine the similarity between the images. For example, the image match system 106 can determine that the input image 202 contains a house façade with six windows, and may utilize this information in finding similar-looking house façades with six windows.

In some embodiments, the image match system 106 retrieves a plurality of images based on the input image 202. The plurality of images retrieved by the image match system 106 can be associated with various property listings.

At (4), the score system 110 determines a score relating to a similarity between the input image 202 and the retrieved image (e.g., the output image 204). The score determined by the score system 110 can include a percentage, a number, a fraction, a descriptor, or any other qualitative or quantitative indication of the similarity between the input image 202 and the output image 204. In some embodiments, the image match system 106 retrieves a plurality of images based on the input image 202. The score system 110 may, at (4), determine a score for each of the plurality of images retrieved by the image match system 106.

In the case when a plurality of images (and corresponding property listings) are retrieved by the image match system 106, the score system 110 may determine a score associated with each image and rank the images based on the scores. For example, the score system 110 may rank high scoring images higher than low scoring images. In some embodiments, the rank in which the images are ordered affects the display of the property listings in the frontend 112. For example, the property listing system 104 may display higher ranking properties at the top of a search results interface, and lower ranking properties proximate to the bottom of the search results interface.

At (5), the score system 110 determines whether the determined score of an image is above a threshold. As noted, at (4), the score system 110 can determine a score associated with an image retrieved by the image match system 106 based on the similar of the image to the input image 202. The threshold can be a percentage, a number, a fraction, or any other threshold indicator. For example, the score system 110 may disregard or discard any image (and associated property listing) with a score of less than 75% (e.g., 75% match or similarity). In addition, at (5), scores generated by the score system 110 may be stored in the score data store 118.

At (6), output image 206 (or multiple output images) and associated property listings are displayed. As described herein, the matching processes may be initiated by a user request, such as a user requesting properties based on the input image. In response to the request and the processes described above, the property listing system 104 may output the matched images and property listings to the user in a search results interface (such as via the frontend 112). In some embodiments, the property listing system 104 can display the output image 204 in a current property listing as “similar properties.”

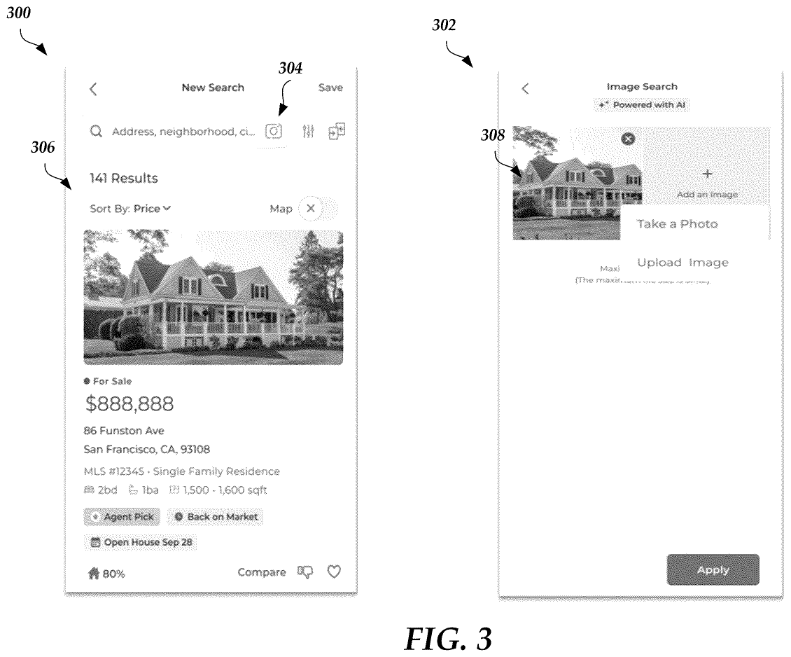

FIG. 3 illustrates example search interface 300 and image input interface 302 in which the property listing system 104 receives a request to perform a property image search. Frontend 112 may include search interface 300 and image input interface 302, which may be displayed on the user device 102.

As shown in FIG. 3, search interface 300 may be displayed to a user of the property listing system 104. Search interface 300 can include an area for a user to input a search request for property listings. Image search request indicator 304 is shown at the top of the search interface 300. Users can interact with the image search request indicator 304 to initiate a search request for property listings based on an input image (or a plurality of images). Also as shown, the search interface 300 can include various tools or features, such as a keyword search field, a filters indicator, an option to save a current search. In addition, the search interface 300 can include a search results area 306 to display the retrieved property listings. Search results area 306 can display property listings and associated images. Additional information pertaining to a property listing can also be displayed in the search results area 306. In some embodiments, a confidence score, such as a match percentage, can be included with the property listing as displayed in the search results area 306.

Image input interface 302 may be configured to allow a user (or other process) to upload an image to be searched. As shown in the image input interface 302, a user may be prompted to upload an image, which can be displayed in image area 308. In some embodiments, the user uploads more than one image to be searched. In some embodiments, there is a maximum number of images that can be uploaded per request. Upon uploading an image and requesting a property search, the results in the search results area 306 can be updated. In addition, the application of any filters (such as via the filter system 108) can update the displayed property listings in the search results area 306.

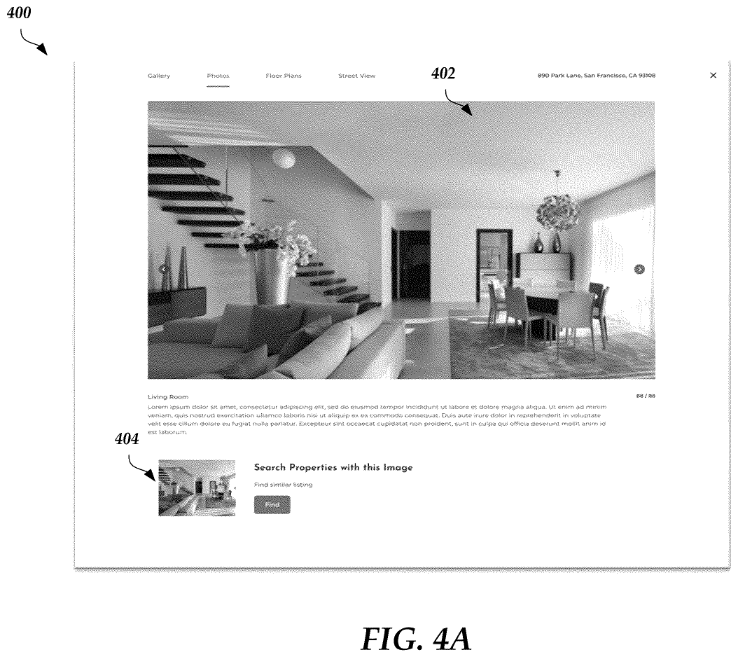

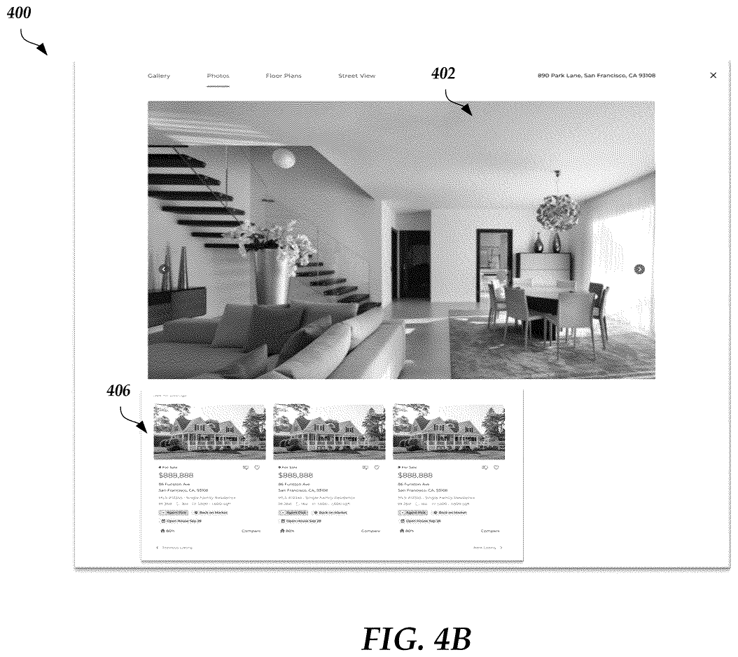

FIGS. 4A-4B are example interfaces in which the property listing system 104 operates to retrieve listings based on image matching, according to various aspects of the present disclosure. Interfaces as shown in FIGS. 4A-4B may be rendered through the frontend 112.

Image viewing interface 400 can be configured to display images of a property listing. As noted herein, property listings can include images showing various rooms, features, layouts, views, etc. of the specific property. In some embodiments, a user can scroll or flip through multiple images associated with the specific property shown in the image viewing interface 400. As shown in FIG. 4A, the image viewing interface 400 can include the gallery image 402 of a living room of an example property. In some embodiments, the image viewing interface 400 can include a similar listings request area 404. Similar listings request area 404 can prompt a user to request the property listing system 104 to retrieve additional property listings with images that are similar to the gallery image 402. In some embodiments, the property listing system 104 may retrieve additional property listings with more than one image associated with the current property listing (but other than just the gallery image 402).

Upon interaction with the similar listings request area 404, the property listing system 104 (such as via the image match system 106) can access the gallery image 402 for the matching processes described herein. For example, the image match system 106 may input the gallery image 402 and an instruction to find similar listings into the model (of model data store 116), and output a property listing with an image that is determined to be similar to the gallery image 402.

As shown in FIG. 4B, similar property listings 406 can be displayed in the image viewing interface 400. In some embodiments, the similar property listings 406 are shown in response to a user request (such as from the similar listings request area 404). In some embodiments, the property listing system 104 may automatically populate the image viewing interface 400 with similar property listings 406 according to the processes described herein.

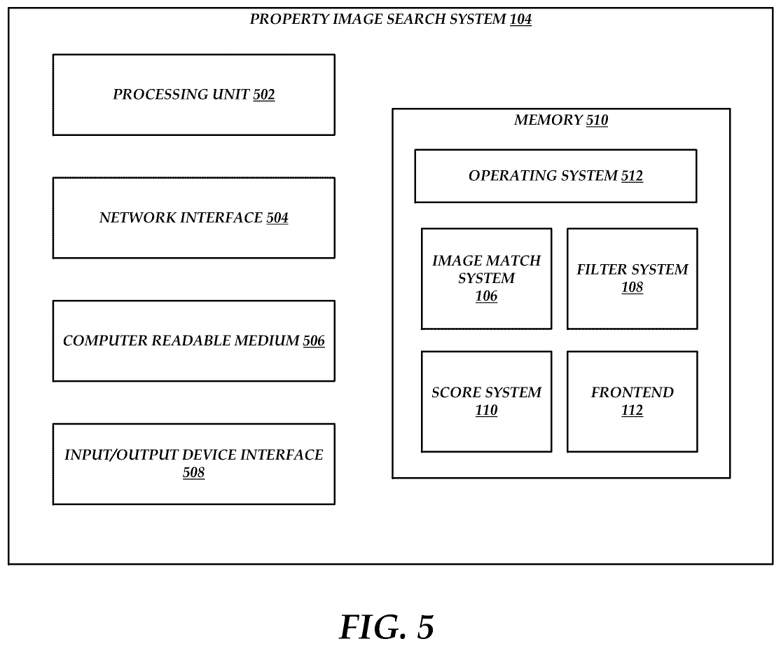

FIG. 5 is a block diagram illustrating components of an example computing system that can be used to implement the various systems and methods described herein.

The general architecture of the system depicted in FIG. 5 includes an arrangement of computer hardware and software that may be used to implement aspects of the present disclosure. The hardware may be implemented on physical electronic devices, as discussed in greater detail below. The system may include many more (or fewer) elements than those shown in FIG. 5. It is not necessary, however, that all of these generally conventional elements be shown in order to provide an enabling disclosure. Additionally, the general architecture illustrated in FIG. 5 may be used to implement one or more of the other components illustrated in the figures. As illustrated, the system includes a processing unit 502, a network interface 504, a computer-readable medium drive 506, and an input/output device interface 508, and memory 510, all of which may communicate with one another by way of a communication bus.

The network interface 504 may provide connectivity to one or more networks or computing systems. The processing unit 502 may thus receive information and instructions from other computing systems or services via the network. The processing unit 502 may also communicate to and from memory 510 and further provide output information for an optional display (not shown) via the input/output device interface 508. The input/output device interface 508 may also accept input from an optional input device (not shown).

The memory 510 may contain computer program instructions (grouped as units in some embodiments) that the processing unit 502 executes in order to implement one or more aspects of the present disclosure, along with data used to facilitate or support such execution. While shown in FIG. 5 as a single set of memory 510, memory 510 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 510 may store an operating system 512 that provides computer program instructions for use by the processing unit 502 in the general administration and operation of the property listing system 104. The memory 510 may further include computer program instructions and other information for implementing aspects of the present disclosure. For example, in one embodiment, the memory 510 includes the image match system 106, THE filter system 108, the score system 110, and the frontend 112. Each of these components may represent code executable to perform the processes described herein.

The system of FIG. 5 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 5 as a property listing system 104, similar components may be utilized in some embodiments to implement other devices shown herein.

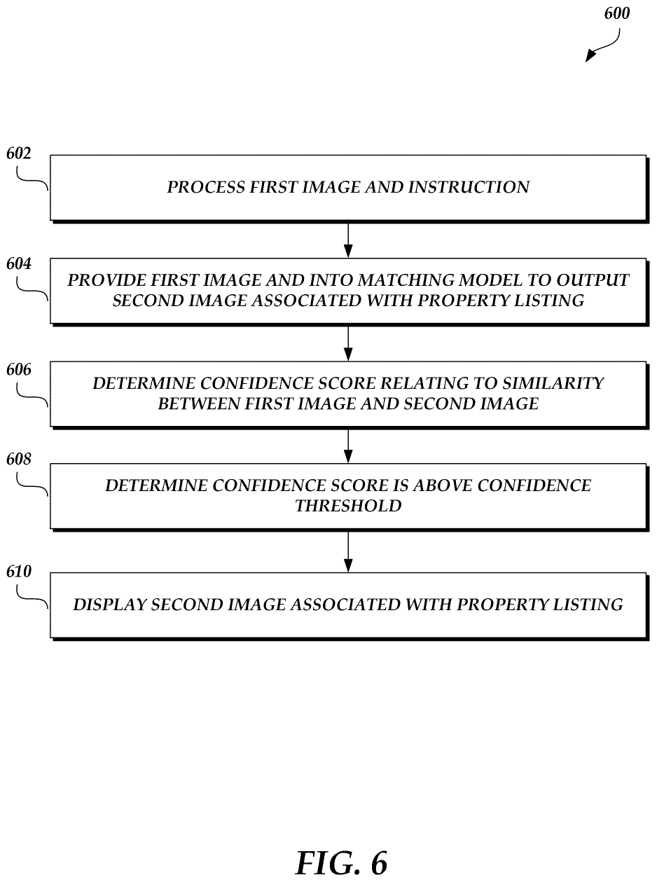

FIG. 6 is a flow diagram showing an example routine 600 for searching for property listings based on an image matching request. Routine 600 may be executed by the property listing system 104 and various components of the property listing system 104. Specifically, the routine 600 may be executed by a processor, such as the processing unit 502, shown in FIG. 5.

At block 602, a first image and an instruction is processed. In some embodiments, the first image and the instruction are included in a request, such as a request from a user device. In some embodiments, the request is received from a user of the user device 102, such as via the frontend 112. In this example, the user may be utilizing a search feature of the property listing system 104. Specifically, the user may desire to search for property listings using an uploaded image (e.g., first image). As noted herein, the first image can include any image relating to a property, such as an exterior image of the property, aerial images, interior images of rooms, floorplans, blueprints, diagrams, drawings, and the like. In some embodiments, the request includes a plurality of images. The request can also include an instruction or prompt. The instruction or prompt may include a request to the model, such as a matching model, for the model to retrieve a similar image from the image data store 114 based on the first image. In further embodiments, the request includes multiple images.

At block 604, the first image is provided into a matching model to output a second image associated with a property listing. In some embodiments, the first image and an instruction to retrieve a similar image from the image data store 114 is provided into the matching model.

In some embodiments, a portion of the first image is provided into the matching model. For example, the user may highlight, select, or crop a portion of the first image to be provided into the matching model. In some embodiments, a portion of the first image may be omitted from being provided into the matching model. For example, areas of the first image that contain people, furniture, text, or other objects can be excluded from the first image. To select (or exclude) portions of the first image, a user can draw, color, highlight, or otherwise select said portion. In some embodiments, the user can add objects to the first image, or to a portion of the first image, such as furniture, decorations, shades, blinds, appliances, colors, painting schemes, wallpaper, etc. The user may do this by drawing, coloring, editing, etc. the first image. In some embodiments, the user may edit the first image by selecting or adding items from a preset list of items. The annotated or modified image can be provided as input into the matching model and processed according to processes described herein.

As noted herein, at block 604, the matching model can be configured to match the first image with images from the image data store 114. To determine whether an image of the image data store 114 is a match to the first image, the image match system 106 may, through the matching model, determine a similarity between the images. The model of the model data store 116 can utilize any computer vision, reverse image, or image processing technique to determine the similarity. This can involve the extraction and matching of characteristic between the images, such as hue, consistency, form, or even other deep neural network embeddings, to gauge similarity. In some embodiments, a semantic similarity can also be utilized to determine the similarity between the images. Additionally, or alternatively, the image match system 106 may, at 604, retrieve a plurality of images (e.g., second images) based on the first image.

At block 606, a confidence score relating to a similarity between the first image and the second image is determined. The score determined by the score system 110 can include a percentage, a number, a fraction, a descriptor, or any other qualitative or quantitative indication of the similarity between the input image 202 and the output image 204. In some embodiments, the image match system 106 retrieves a plurality of images based on the first image. The score system 110 may, at 606, determine a score for each of the plurality of images retrieved by the image match system 106.

Additional processes relating to the score can be executed by the property listing system 104. For example, at block 608, the confidence score is determined to be above a confidence threshold. The confidence threshold can include any percentage, number, fraction, or other threshold indicator. For example, at block 608, the score system 110 may determine whether the score of the second image is above a 50% confidence (e.g., match or similarity) to the first image. If the score system 110 determines that the confidence score of the second image is above the confidence threshold, the second image may be retained for further processing (e.g., display, transmission).

In addition, in some examples, the score system 110 can rank the images based on the scores. For example, the score system 110 may rank high scoring images higher than low scoring images. In some embodiments, the rank in which the images are ordered affects the display of the property listings in the frontend 112, such as at block 610. For example, the property listing system 104 may display higher ranking properties at the top of a search results interface, and lower ranking properties proximate to the bottom of the search results interface.

In some embodiments, filters can be applied by the filter system 108 to the images retrieved by the image match system 106. Based on the filters, the images (and property listings) may be updated. For example, the image match system 106 may discard certain retrieved images that do not fall within the specified filters. In some embodiments, the application of filters to the retrieved images can occur before the images are displayed to the user, such as in block 610. In some embodiments, the retrieved images can be stored and retrieved by the image match system 106 in the case that a user updates the filters. In this case, previously hidden or discarded images (and corresponding property listings) can be retrieved upon the updating of the applied filters by the user.

At block 610, the second image associated with the property listing is displayed. As noted above, the processes described in routine 600 can originate with a user request for property listings based on the first image. As such, in response to the request, the property listing system 104 can display the second image, including the associated property listing, and other retrieved property listings in an interface. Specifically, in response to the request and the processes described above, the property listing system 104 may output the second image (e.g., matched images) and property listings to the user in a search results interface (such as via the frontend 112). In some embodiments, depending on the ranking, the property listing system 104 can display the results according to the scores of the retrieved images. In some embodiments, the ranking of the plurality of output/retrieved images is based on a weighted average.

In some embodiments, the property listing system 104 may input multiple images into the matching model. In response to multiple images as input, the image match system 106 may retrieve one or more than one matching image (e.g., more than one matching property listing). In some embodiments, confidence scores can be calculated for each input image relating to each retrieved image. For example, for each input image and each retrieved image, the score system 110 can calculate a confidence score for each pairing. The confidence scores for each input image and each retrieved image can then be used by the property listing system 104 to determine which listings to display to the user, or the ranking/ordering in which to display to the user. Based on a comparison between the confidence scores, properties may be ranked. As a simple example, a request can include a first image and a second image. In response to inputting both images into the matching model, the matching model can retrieve a third image corresponding to a first listing and a fourth image corresponding to a second listing. The score system 110 can determine a first confidence score relating to the similarity between the first image and the third image, and a second confidence score relating to the similarity between the first image and the fourth image. The score system 110 can also determine a third confidence score relating to the similarity between the second image and the third image, and a fourth confidence score relating to the similarity between the second image and the fourth image. In some embodiments, the image match system 106 may hide or discard images whose confidence scores are below a confidence threshold. In some embodiments, an average confidence score can be calculated that takes into account all the confidence scores relating to a particular retrieved image. In this case, for example, if the average confidence score is below a confidence threshold, the image match system 106 may discard or hide the property listing. In some embodiments, the confidence scores can be used to order or rank the images. For example, the image with the highest confidence score (e.g., averaged) can be ranked at the top of the list, while retrieved images with lower confidence scores can be ranked at the bottom of the list. In some embodiments, a preferred image can be selected as the input image. In this case, the image match system 106 may take into account (e.g., weighting more heavily) matches with the preferred image, as opposed to secondary images that are included as input. Any combination or configuration of selecting images can be utilized by the property listing system 104 to match, rank, order, and display the retrieved images.

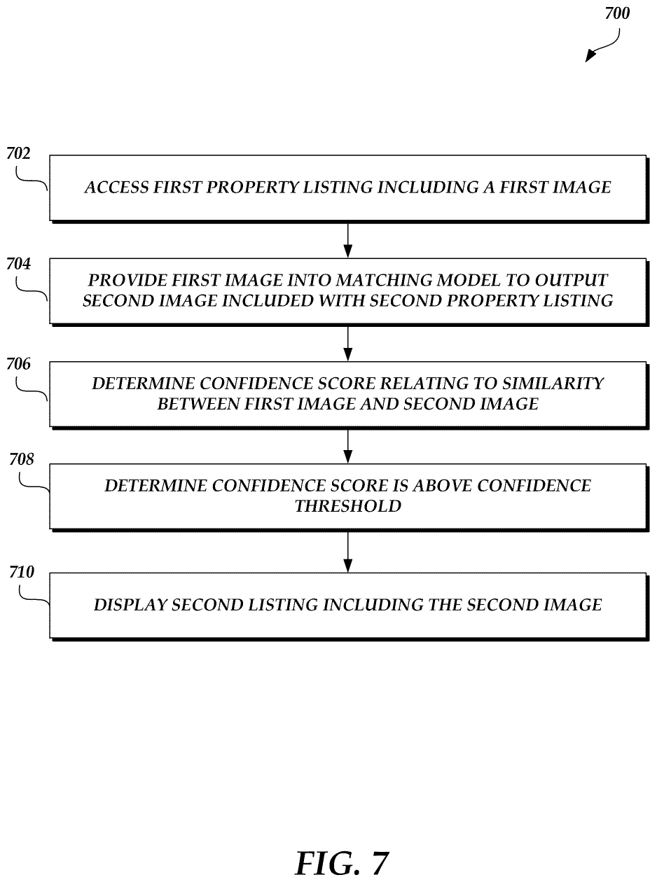

FIG. 7 is a flow diagram showing an example routine 700 for searching for property listings based on image matching of a current property listing. Routine 700 may be executed by the property listing system 104 and various components of the property listing system 104. Specifically, the routine 700 may be executed by a processor, such as the processing unit 502, shown in FIG. 5.

At block 702, a first property listing including a first image is accessed. In some embodiments, the property listing system 104 may access a current property listing that includes multiple images at block 702. As noted herein, the first image can include any image relating to a property, such as an exterior image of the property, aerial images, interior images of rooms, floorplans, blueprints, diagrams, drawings, and the like. In some embodiments, the request includes a plurality of images. The request can also include an instruction or prompt. The instruction or prompt may include a request to the model, such as a matching model, for the model to retrieve a similar image from the image data store 114 based on the first image. In further embodiments, the first property listing includes multiple images that are accessed and processed in a manner as described below with respect to FIG. 7.

At block 704, the first image is provided as input into a matching model to output a second image included with a second property listing. In some embodiments, the first image and an instruction to retrieve a similar image from the image data store 114 is provided into the matching model.

In some embodiments, a portion of the first image is provided into the matching model. For example, the user may highlight, select, add object(s), or crop a portion of the first image to be provided into the matching model. In some embodiments, a portion of the first image may be omitted from being provided into the matching model. For example, areas of the first image that contain people, furniture, text, or other objects can be excluded from the first image.

As noted herein, at block 704, the matching model can be configured to match the first image with images from the image data store 114. To determine whether an image of the image data store 114 is a match to the first image, the image match system 106 may, through the matching model, determine a similarity between the images. The model of the model data store 116 can utilize any computer vision, reverse image, or image processing technique to determine the similarity. This can involve the extraction and matching of characteristic between the images, such as hue, consistency, form, or even other deep neural network embeddings, to gauge similarity. In some embodiments, a semantic similarity can also be utilized to determine the similarity between the images. Additionally, or alternatively, the image match system 106 may, at block 704, retrieve a plurality of images (e.g., second images) based on the first image.

At block 706, a confidence score relating to a similarity between the first image and the second image is determined. The score determined by the score system 110 can include a percentage, a number, a fraction, a descriptor, or any other qualitative or quantitative indication of the similarity between the input image 202 and the output image 204. In some embodiments, the image match system 106 retrieves a plurality of images based on the first image. The score system 110 may, at block 706, determine a score for each of the plurality of images retrieved by the image match system 106.

Additional processes relating to the score can be executed by the property listing system 104. For example, at block 708, the confidence score is determined to be above a confidence threshold. The confidence threshold can include any percentage, number, fraction, or other threshold indicator. For example, at block 608, the score system 110 may determine whether the score of the second image is above a 50% confidence (e.g., match or similarity) to the first image. If the score system 110 determines that the confidence score of the second image is above the confidence threshold, the second image may be retained for further processing (e.g., display, transmission).

In addition, in some examples, the score system 110 can rank the images based on the scores. For example, the score system 110 may rank high scoring images higher than low scoring images. In some embodiments, the rank in which the images are ordered affects the display of the property listings in the frontend 112, such as at block 610. For example, the property listing system 104 may display higher ranking properties at the top of a search results interface, and lower ranking properties proximate to the bottom of the search results interface.

In some embodiments, filters can be applied by the filter system 108 to the images retrieved by the image match system 106. Based on the filters, the images (and property listings) may be updated. For example, the image match system 106 may discard certain retrieved images that do not fall within the specified filters. In some embodiments, the application of filters to the retrieved images can occur before the images are displayed to the user, such as in block 710. In some embodiments, the retrieved images can be stored and retrieved by the image match system 106 in the case that a user updates the filters. In this case, previously hidden or discarded images (and corresponding property listings) can be retrieved upon the updating of the applied filters by the user.

At block 710, the second listing including the second image is displayed. As noted above, the processes described in routine 700 can originate from an automated request for similar property listings to include with a current property listing. As such, the property listing system 104 can display the second image, including the associated property listing, and other retrieved property listings in an interface, such as image viewing interface 400. Specifically, in response to the request and the processes described above, the property listing system 104 may output the second image (e.g., matched images) and property listings to the user in the image viewing interface 400 (such as via the frontend 112). In some embodiments, depending on the ranking, the property listing system 104 can display the results according to the scores of the retrieved images. In some embodiments, the ranking of the plurality of output/retrieved images is based on a weighted average.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules, including one or more specific computer-executable instructions, that are executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of electronic devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable electronic device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached FIGs. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

What is claimed is:

1. A system, comprising:
a computer-readable storage medium storing computer-executable instructions; and
one or more processors, wherein the computer-executable instructions, when executed by the one or more processors, cause the one or more processors to:
process a first image and an instruction received from a user device;
provide the first image and the instruction as an input to a matching model, wherein providing the first image and the instruction as input to the matching model causes the matching model to output a second image associated with a first property listing;
determine a first confidence score relating to a first similarity between the first image and the second image;
determine that the first confidence score is above a confidence threshold; and
cause the first property listing to be displayed in a user interface on the user device, wherein the first property listing includes the second image.

2. The system of claim 1, wherein the computer-executable instructions, when executed, further cause the one or more processors to process a third image received from the user device.

3. The system of claim 2, wherein the computer-executable instructions, when executed, further cause the one or more processors to:
provide the first image, the third image, and the instruction as input to the matching model to cause the matching model to output the second image associated with the first property listing;
determine a second confidence score relating to a second similarity between the third image and the second image; and
determine that the first confidence score and the second confidence score are above the confidence threshold.

4. The system of claim 2, wherein the computer-executable instructions, when executed, further cause the one or more processors to:
provide the first image, the third image, and the instruction as input to the matching model to cause the matching model to output the second image associated with the first property listing and a fourth image associated with a second property listing;
determine a second confidence score relating to a second similarity between the third image and the fourth image; and
rank the second image and the fourth image based on a comparison between the first confidence score and the second confidence score.

5. The system of claim 2, wherein ranking of the first image and the third image is based on a weighted average.

6. The system of claim 1, wherein the instruction is a request for property listings similar to the first image.

7. The system of claim 1, wherein the matching model is to output a third image associated with a second property listing.

8. The system of claim 7, wherein the computer-executable instructions, when executed, further cause the one or more processors to:
determine a second confidence score relating to a similarity between the first image and the third image; and
rank the first property listing and the second property listing based on a comparison between the first confidence score and the second confidence score.

9. The system of claim 1, wherein the computer-executable instructions, when executed, further cause the one or more processors to filter the first property listing based on a filter parameter.

10. The system of claim 1, wherein the matching model is a machine learning model.

11. A method, comprising:
accessing a first property listing on a user device, wherein the first property listing includes a first image;
providing the first image as input into a matching model, wherein providing the first image as input to the matching model causes the matching model to output a second image included with a second property listing;
determining a first confidence score relating to a first similarity between the first image and the second image;
determining that the first confidence score is above a confidence threshold; and
displaying the second property listing, wherein the second property listing includes the second image.

12. The method of claim 11, wherein the first property listing includes a plurality of images.

13. The method of claim 11, wherein the matching model is to output a third image associated with the second property listing.

14. The method of claim 13, further comprising:
determining a second confidence score relating to a similarity between the first image and the third image; and
ranking the first property listing and the second property listing based on a comparison between the first confidence score and the second confidence score.

15. The method of claim 14, wherein ranking of the first image and the third image is based on a weighted average.

16. The method of claim 11, further comprising filtering the first property listing based on a filter parameter.

17. One or more non-transitory computer-readable media storing computer-executable instructions that, when executed by a computing system comprising a processor, cause the computing system to:
process a first image and an instruction received from a user device;
provide the first image and the instruction as an input to a matching model, wherein providing the first image and the instruction as input to the matching model causes the matching model to output a second image associated with a first property listing;
determine a first confidence score relating to a similarity between the first image and the second image;
determine that the first confidence score is above a confidence threshold; and
cause the first property listing to be displayed in a user interface on the user device, wherein the first property listing includes the second image.

18. The one or more non-transitory computer-readable media of claim 17, wherein the matching model is to output a third image associated with a second property listing.

19. The one or more non-transitory computer-readable media of claim 18, wherein the computer-executable instructions, when executed, further cause the computing system to:
determine a second confidence score relating to a similarity between the first image and the third image; and
rank the first property listing and the second property listing based on a comparison between the first confidence score and the second confidence score.

20. The one or more non-transitory computer-readable media of claim 17, wherein the computer-executable instructions, when executed, further cause the computing system to filter the first property listing based on a filter parameter.
